(19) United States
(12) Patent Application Publication
(10) Pub. No.: US 2015/0058909 A1
(43) Pub. Date: Feb. 26, 2015

(54) Set-top Box with Technical Configuration and System and Method for Use of Same

(71) Applicant: Enseo, Inc., Richardson, TX (US)

(72) Inventors: Tom Miller, Plano, TX (US); Bill Fang, Plano, TX (US); Vanessa Ogle, Fairview, TX (US)

(21) Appl. No.: 14/312,653

(22) Filed: Jun. 23, 2014

Related U.S. Application Data
(60) Provisional application No. 61/837,852, filed on Jun. 21, 2013.

(51) Int. Cl. H04N 21/6547; H04N 21/262; H04N 21/443; H04N 21/426; H04N 21/45

(52) U.S. Cl. CPC H04N 21/6547; H04N 21/4263; H04N 21/4516; H04N 21/443; H04N 21/26291
USPC 725/132

(57) ABSTRACT

A set-top box with a technical configuration and system and method for use of the same are disclosed. In one embodiment of the set-top box, the set-top box executes an technical protocol to make the set-top box and an associated television ready for use. During the installation, maintenance, or repair, a human-readable visual label and a machine-readable optical label are generated that contain information about the status of the technical protocol. The labels are forwarded, via the television output, to the television. The set-top box dynamically updates the human-readable visual label and the machine-readable optical label as the status of the technical protocol changes.

### PRIORITY STATEMENT

This application claims priority from co-pending U.S. Patent Application Ser. No. 61/837,852 entitled “Guest User Identification Device and Method” and filed on Jun. 21, 2013 in the name of Vanessa Ogle; which is hereby incorporated by reference for all purposes.

### TECHNICAL FIELD OF THE INVENTION

This invention relates, in general, to set-top boxes and, in particular, to set-top boxes with installation, maintenance, and repair configurations and systems and methods for use of the same that assist an operator with technical tasks.

### BACKGROUND OF THE INVENTION

Without limiting the scope of the present invention, the background will be described in relation to televisions in the hospitality lodging industry, as an example. During hotel television and set-top box installation processes, installation operators keep track of the progress and problems, if any, of the configuration manually. Such record keeping is difficult and prone to errors. Moreover, unresolved errors may result in multiple trips to the same location to completely troubleshoot a problem. As a result of limitations in existing technology, installation and configuration of televisions and set-top boxes is a frequent complaint and source of aggravation to installation operators and supervisors. Accordingly, there is a need for improved systems and methods for installing televisions and set-top boxes.

### SUMMARY OF THE INVENTION

It would be advantageous to introduce systems and methods that further the completion of technical tasks—and other installation, maintenance, and repair tasks—in hospitality lodging establishments and other transitory establishments to ensure completion of the tasks and reduce failure. It would also be desirable to enable a computer-based solution that would mitigate the dependency and issues with manually logged and manually verified installations, maintenance, and repair tasks. To better address one or more of these concerns, a set-top box with a technical configuration and system and method for use of the same are disclosed. In one embodiment of the set-top box, the set-top box executes a technical protocol related to installation, maintenance, or repair, for example, to make the set-top box and an associated television ready for use. During the technical operation, a human-readable visual label and a machine-readable optical label are generated that contain information about the status of the technical protocol. The labels are forwarded, via the television output, to the television. The set-top box dynamically updates the human-readable visual label and the machine-readable optical label as the status of the technical protocol changes. These and other aspects of the invention will be apparent from and elucidated with reference to the embodiments described hereinafter.

### BRIEF DESCRIPTION OF THE DRAWINGS

For a more complete understanding of the features and advantages of the present invention, reference is now made to the detailed description of the invention along with the accompanying figures in which corresponding numerals in the different figures refer to corresponding parts and in which:

FIG. 1 is schematic diagram depicting one embodiment of a system utilizing set-top boxes with technical configurations being employed in a hospitality lodging establishment, according to the teachings presented herein;

FIG. 2 is a front elevation view of one embodiment of a room within the hospitality lodging establishment, illustrating components in the technical configuration, which form a portion of the system depicted in FIG. 1;

FIG. 3A is a front elevation view of one embodiment of a set-top box depicted in FIG. 1 in further detail;

FIG. 3B is a rear elevation view of the set-top box depicted in FIG. 3A;

FIG. 4 is a functional block diagram depicting one embodiment of the set-top box presented in FIGS. 4A and 4B; and

FIG. 5 is a flow chart depicting one embodiment of a method utilizing set-top boxes with technical configurations according to the teachings presented herein.

### DETAILED DESCRIPTION OF THE INVENTION

While the making and using of various embodiments of the present invention are discussed in detail below, it should be appreciated that the present invention provides many applicable inventive concepts, which can be embodied in a wide variety of specific contexts. The specific embodiments discussed herein are merely illustrative of specific ways to make and use the invention, and do not delimit the scope of the present invention.

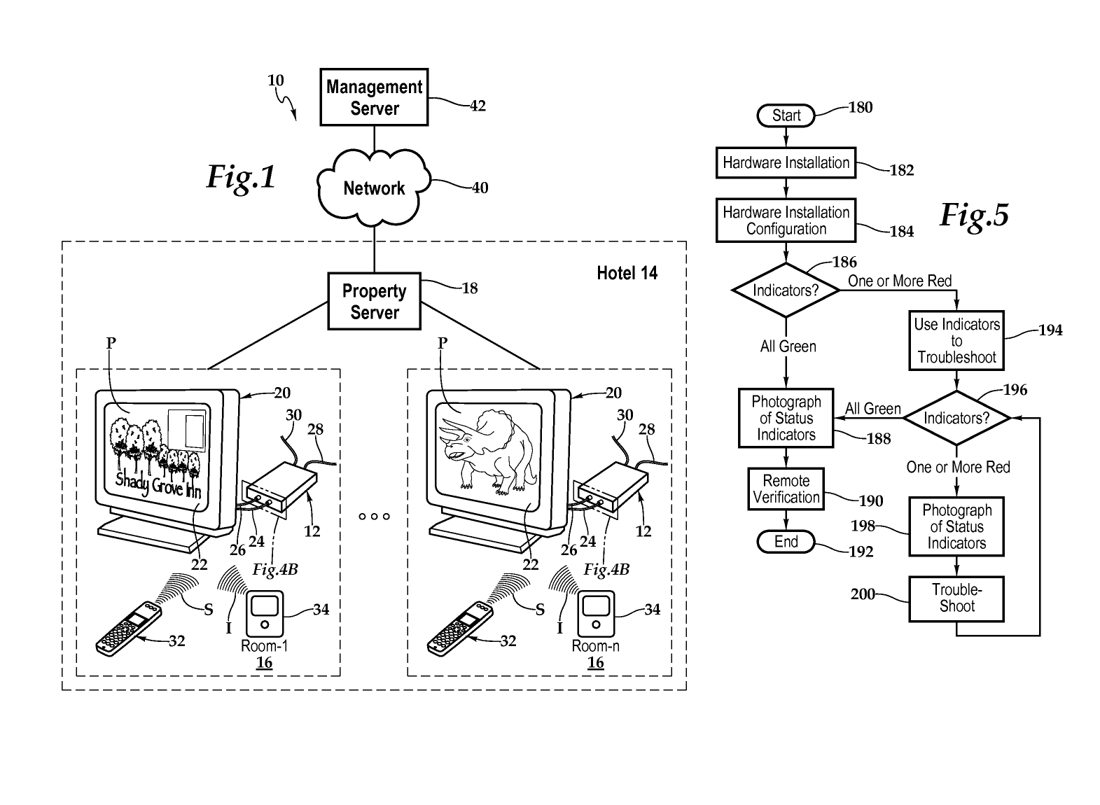

Referring initially to FIG. 1, therein is depicted one embodiment of a system 10 utilizing set-top boxes 12 with interactive portals being employed within a hospitality lodging establishment 14. The hospitality lodging establishment or more generally, hospitality property, may be a furnished multi-family residence, dormitory, lodging establishment, hotel, hospital, or other multi-unit environment or other transitory living establishment. As shown, by way of example and not by way of limitation, the hospitality environment is depicted as the hotel 14 having various rooms 16. The set-top boxes 12 are communicatively disposed with various amenities associated with the hospitality environment, which as mentioned is depicted as the hotel 14. The set-top boxes 12 may be deployed throughout the rooms 16 of the hotel 14 and are in communication with a property server 18, which is co-located at the hotel 14.

As shown, in one embodiment, within a room 16, the system 10 includes the set-top box 12 and a display illustrated as television 20 having a screen 22. A connection, which is depicted as an HDMI connection 24, connects the set-top box 12 to the television 20. Other connections include a power cable 26 coupling the set-top box 12 to a power source, a coaxial cable 28 coupling the set-top box 12 to an external cable source, and a category five (Cat 5) cable 30 coupling the set-top box 12 to external pay-per-view source at the hotel 14. It should be appreciated that the cabling connected to the set-top box 12 will depend on the environment and application and the cabling connections presented in FIG. 1 are depicted for illustrative purposes. Further, it should appreciated that the positioning of the set-top box 12 will vary depending on environment and application and, with certain functionality, the set-top box 12 may be placed more discretely, or even entirely, behind the television 20.

A television remote control 32 includes an array of buttons for adjusting various settings such as television channel and volume and for providing various inputs during the installation, maintenance, or repair of the set-top boxes 12 and the televisions 20, as discussed in more detail hereinbelow. In one embodiment, the television remote control 30 may be a consumer infrared (IR), Bluetooth or other wireless-protocol-based device configured as a small wireless handheld object that issues commands, such as signals S, from a distance to the set-top box 12 in order to control the television 20 via the set-top box 12, for example. By way of example, program P is being shown on the screen 22 of the television 20. Moreover, the on-site property server 18 is in communication via a network 40 with a management server 42.

As part of the installation, maintenance or repair of the set-top boxes 12 and the televisions 20, an installation operator or technician (not shown) may have a mobile device 34, such as pad or phone, which is capable of capturing images I, including capturing images I of the screen 22 of the television 20. It should be appreciated that the teachings presented herein not only apply to installation but maintenance, repair, and other technical tasks as well.

In operation, the set-top box 12 is able to automatically download software applications, upload software and update content packages, for example. Tracking and installation progress and reporting the trouble items may also be automated by using the hotel network and network connections beyond the hotel, including connections that interact with a cloud server such that information, including substantially real-time information, can be accessed by any members of the installation team and managers.

As presented herein, the same installation, maintenance, and repair information that is typically uploaded or transmitted through a network may be reported directly to the television screen for the technician to view and, optionally, capture via a mobile device as described in further detail hereinbelow. That is, as presented herein, in one embodiment, the set-top box may be considered as having a technical widget functionality that automates functions to be performed during installation, maintenance, and repair. Moreover, at the same time, the set-top box may self-perform various tests on critical aspects of the set-top box and television. The real-time reports which are generated may be transmitted through the hotels infrastructure or alternatively, captured on the television screen in the form of a machine-readable optical label, thereby creating a second, alternative or backchannel of communication for redundant communication during a technical task, such as installation, maintenance, or repair.

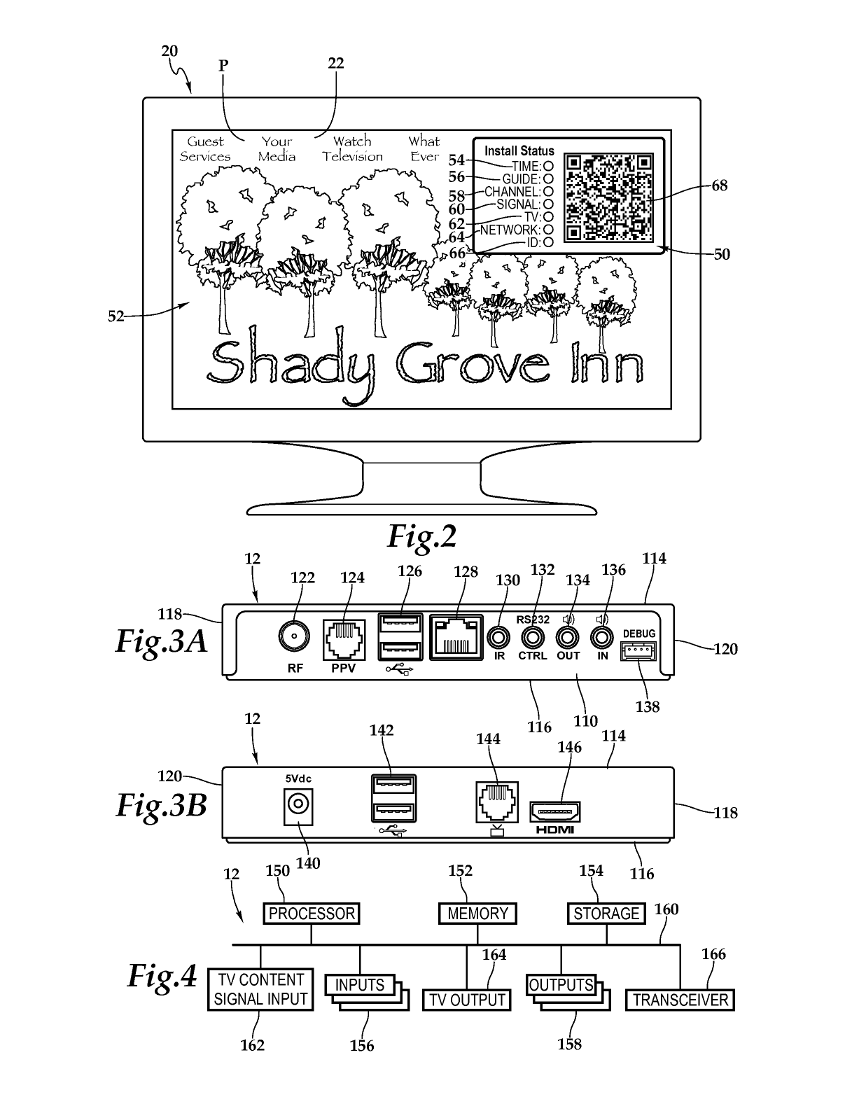

Referring now to FIG. 2, in response to receiving a request for installation or maintenance or repair, for example, from a user (e.g., a technician) of the remote control 32 the set-top box 12 has generated a technical status portal 50 embedded within an interactive portal 52, which may be default or other content. In one implementation, the technician may press a service button or navigate a menu or otherwise interact with the set-top box 12 to cause the generation of the portals 50, 52 which may be overlayed, superimposed, or embedded on the program P in one embodiment. The technical status portal includes visual indicators 54, 56, 58, 60, 62, 64, and 66 for establishing, by way of example, and not by way of limitation, a valid time source at the set-top box, a valid entertainment guide at the set-top box, valid digital channel tuning at the set-top box from the television input, valid signal quality at the set-top box from the television input, valid television control signals at the set-top box being sent via the television output, valid network connectivity at the set-top box, valid wireless connectivity at the set-top box, and a valid room identification at the set-top box, respectively. In one implementation, the visual indicators 55 through 66 include colored labels, such as green, yellow, and red to indicate if a result is favorable, cautionary, or problematic, for example. It should be appreciated that the technical indicators may vary depending on the technical task, such as installation, maintenance or repair, for example.

The following table, Table I, summarizes the various labels and colors in one exemplary embodiment.

TABLE I
On Screen Visual Labels

| Label | Green | Yellow | Red |
|---|---|---|---|
| TIME | Valid | n/a | No Time |
| | Time | | Source, |
| | Source | | STB time |
| | | | is |
| | | | invalid |
| GUIDE | Full | Partial | No Guide |
| | Guide | Guide | Data |
| | Data is | Data | Available |
| | available | Available | |
| CHANNEL | Digital | n/a | Digital |
| | Channel | | Channel |
| | Tune | | Tune |
| | success | | Failure |
| SIGNAL | Q AM | QAM | QAM SNR |
| | SNR >= 32 dB | SNR >= 29 | <29 or no |
| | | | signal |
| TV | TV | Generic | TV not |
| | Control | mode | under |
| | in effect | enabled | control |
| NETWORK | Address | Address | No |
| | valid & | assigned | Network |
| | beacon | | |
| | received | | |
| WIRELESS | Address | Address | No |
| | valid & | assigned | Wireless |
| | beacon | | Network |
| | received | | |
| ID | Room ID | n/a | Room ID |
| | Set | | not yet |
| | | | set |

The techncial status portal 50 also includes a machine-readable optical label 68, which may be a Quick Response (QR) code, for example. The diagnostic and trouble shooting functions of the set-top box 12 not only generate the human-readable visual labels 54 though 68, but a corresponding machine-readable optical label 68, including specific diagnostic information about the technical protocol, which may relate to installation, maintenance, or repair, for example. The machine-readable optical label 68 may derived from a bitmask such as little Endian. The following table, Table II, summarizes the one exemplary embodiment of the coding.

TABLE II
Exemplary Coding of QR Code

| BIT | Test | Notes |
|---|---|---|
| 20 | Run WiFi | |
| | Check | |
| 19 | WiFi result | Only run of bit 20 set, 1 == WiFi |
| | | connected to a peer and signal |
| | | strength is not on the edge |
| 18 | Run room ID | |
| | check | |
| 17 | Room Test | Only run bit 18 set, 1 == RoomID set |
| | Result | |
| 16 | Run MDP | |
| | Beaconer | |
| | check | |
| 15 | MDP Beaconer | Only run if bit 16 set, 1 == An MDP |
| | result | Beaconer has been seen on the |
| | | network |
| 14 | Run Network | |
| | Check | |
| 13 | Network | Only run is Bit 14 set, 1 == Default |
| | result | net interface has a valid IP address |
| 12 | Run TV Check | |
| 10 | TV result | Only run if Bit 12 set, (2 bits) 3 = TV |
| | | control enabled and TV ID'ed, |
| | | 1 = Generic mode, 0 = TV Control mode |
| | | but NoTV |
| 9 | Run Channel | |
| | Check | |
| 8 | Channel | Only run if bit 9 set, 1 = digital |
| | Result | channel successfully tuned |
| 6 | SNR result | Only run if bit 9 set, (2 bits) |
| | | 3 = SNR >= 32, 1 = SNR >= 29, 0 if less |
| 5 | Run Guide | |
| | Check | |
| 3 | Guide Result | Only run if bit 5 set, (2 |
| | | bits) 3 = guide max days loaded, 1 == at |
| | | least one day guide data loaded, |
| | | 0 == failed |
| 2 | Time Result | Only run if bit 1 set, 1 == valid time |
| | | source found |
| 1 | Run Time | |
| | Check | |
| 0 | QA | 1 == QA Result has been acknowledged, |
| | Acknowledged | either by IR setup remote or network |
| | | ACK |

Both the human-readable visual labels 54 through and the machine-readable optical label 68 may be continuously updated throughout the installation or maintenance or repair process in order to provide the installer or technician with a visual indication of the status and, when necessary, a machine-readable optical code which may be captured and shared via a mobile device, for example, with a remote system for verification or troubleshooting purposes. It should be appreciated that any number or configuration of technical status icons may be presented, including an entire screen of technical status icons or a scrolling feature allowing a defined space to provide many sheets of informative technical status icons.

Referring now to FIG. 3A, FIG. 3B, and FIG. 4, as used herein, set-top boxes, back boxes and set-top/back boxes may be discussed set-top back boxes. By way of example, the set-top box 12 may be a set-top unit that is an information appliance device that generally contains set-top box functionality including having a television-tuner input and displays output through a connection to a display or television set and an external source of signal, turning by way of tuning the source signal into content in a form that can then be displayed on the television screen or other display device. Such set-top boxes are used in cable television, satellite television, and over-the-air television systems, for example.

The set-top box 12 includes a housing 108 having a front wall 110, rear wall 112, top wall 114, bottom base 116, and two sidewalls 118, 120. It should be appreciated that front wall, rear wall, and side wall are relative terms used for descriptive purposes and the orientation of the walls may vary depending on application. The front wall includes various ports, ports 122, 124, 126, 128, 130, 132, 134, 136, and 128 that provide interfaces for various interfaces, including inputs and outputs. In one implementation, as illustrated, the ports 122 through 128 include inputs 156 and outputs 158 and, more particularly, an Rf input 122, a RJ45 input 124, universal serial bus (USB) input/outputs 126, an Ethernet category 5 (Cat 5) coupling 128, an internal reset 130, an RS232 control 132, an audio out 134, an audio in 136, and a debug/maintenance port 138. The rear wall 112 also includes various inputs 156 and outputs 158. More particularly, ports 140, 142, 144, and 146 include a 5V dc power connection 140, USB inputs/outputs 142, an RJ-45 coupling 144, and an HDMI port 146. It should be appreciated that the configuration of ports may vary with the set-top box depending on application and context.

Within the housing 108, a processor 150, memory 152, storage 154, the inputs 156, and the outputs 158 are interconnected by a bus architecture 160 in a mounting architecture. The processor 150 may process instructions for execution within the computing device, including instructions stored in the memory 152 or in storage 154. The memory 152 stores information within the computing device, as shown, the set-top box 12. In one implementation, the memory 152 is a volatile memory unit or units. In another implementation, the memory 152 is a non-volatile memory unit or units. Storage 154 provides capacity that is capable of providing mass storage for the set-top box 12. As discussed, various inputs 156 and outputs 158 provide connections to and from the computing device, wherein the inputs 156 are the signals or data received by the set-top box 12, and the outputs 156 are the signals or data sent from the set-top box 12.

A television content signal input 162 and a television output 164 are also secured in the housing 108 in order to receive content from a source, that is, a source external to the set-top box 12, in the hospitality property, for example, and forward the content to the television located within the hotel room, for example. A transceiver 166 is associated with the set-top box 12 and communicatively disposed with the bus 160. As shown the transceiver 166 may be internal, external, or a combination thereof to the housing 108. Further, the transceiver may include an antenna. Communication between various amenities in the hotel room, including even the remote control 32, and the set-top box 12 may be enabled by a variety of wireless methodologies employed by the transceiver 56, including 802.11, 3G, 4G, Edge, WiFi, ZigBee, near field communications (NFC), Bluetooth low energy and Bluetooth, for example. Also, infrared (IR) may be utilized.

The memory 152 and storage 154 are accessible to the processor 150 and include processor-executable instructions that, when executed, cause the processor 150 to execute a series of operations. The processor-executable instructions receive installation instructions via the antenna and then execute a technical protocol to make the set-top box and television ready for use and address the technical issue, whether installation, maintenance, or repair, for example. The processor-executable instructions then generate a human-readable visual label that contains information about the status of the technical protocol. Further, a machine-readable optical label is generated that contains information about the status of the technical protocol. The television output forwards the human-readable visual label and the machine-readable optical label to the television. The processor-executable instructions dynamically update the human-readable visual label and the machine-readable optical label as the status of the technical protocol changes.

Referring now to FIG. 4, one embodiment of a method utilizing set-top boxes with installation, as an example, within the hospitality lodging industry, as an example, is depicted. It should be appreciated that the methodology presented herein is also applicable to maintenance and repair as well. At block 180, the methodology is initiated and advancing to block 182 the hardware installation begins with the various connections of the set-top box and television being completed. At block 184, an installation operator initializes the installation configuration of the set-top box by, in one embodiment, actuating a code on a remote control associated with the set-top box. At decision block 186, as the installation process progresses, the installer views the television screen for the visual indicators, which, in one implementation, light green or red to show progress on several installation protocol items.

If the visual indicator lights are all green, then the methodology advances to block 188, where the installer captures a photograph or image of the machine-readable optical label and forwards the same at block 190 to a verification system, which may be a property server on-site or alternatively, a property management or maintenance server off-site. It should be appreciated that other forms of verification, including communication between any on-site property server or an off-site property management server may also occur with the set-top box as part of the installation process. The transmission of the machine-readable optical code by an alternative route, i.e., mobile device backchannel provides additional verification. At block 192, the methodology ends.

Returning to decision block 186, if one or more indicators are red, then the methodology advances to block 194 where the installer uses the indicators to trouble shoot or diagnose the problem. At decision block 196, if following diagnostic action, the indicators are all green, then the flow chart advances to previously discussed block 188. On the other hand, if one or more indicators are still red, then an image or photograph of the machine-readable optical label is captured at block 198 and transmitted at block 200 to provide escalated and remote trouble shooting. As previously discussed, the machine-readable optical label provides diagnostic information, which can be read at the remote location to provide insight into the nature of the problem. Moreover, often during installation and maintenance when issues occur, the set-top box under work may not be in communication with the remote site. Therefore, the methodology presented herein provides an alternative channel of communication of data relevant to the installation issue. Following block 200, the methodology returns to decision block 196.

The order of execution or performance of the methods and data flows illustrated and described herein is not essential, unless otherwise specified. That is, elements of the methods and data flows may be performed in any order, unless otherwise specified, and that the methods may include more or less elements than those disclosed herein. For example, it is contemplated that executing or performing a particular element before, contemporaneously with, or after another element are all possible sequences of execution.

While this invention has been described with reference to illustrative embodiments, this description is not intended to be construed in a limiting sense. Various modifications and combinations of the illustrative embodiments as well as other embodiments of the invention, will be apparent to persons skilled in the art upon reference to the description. It is, therefore, intended that the appended claims encompass any such modifications or embodiments.

What is claimed is:

1. A set-top box with technical configuration comprising:
a housing securing a television input, a television output, a processor, memory, storage, a first tuner, and a second tuner therein;
a busing architecture communicatively interconnecting the television input, the television output, the processor, the memory, the storage, the first tuner, and the second tuner therebetween;
the television input configured to receive a source signal from an external source;
the television output configured to forward an output signal to a television; and
the memory accessible to the processor, the memory including processor-executable instructions that, when executed, cause the processor to:
execute a technical protocol to make the set-top box and television ready for use;
generate a human-readable visual label that contains information about the status of the technical protocol;
generate a machine-readable optical label that contains information about the status of the technical protocol;
forward, via the television output, the output signal including the human-readable visual label and the machine-readable optical label; and
dynamically update the human-readable visual label and the machine-readable optical label as the status of the technical protocol changes.

2. The set-top box as recited in claim 1, wherein the technical protocol is selected from the group consisting of installation protocols, maintenance protocols, and repair protocols.

3. The set-top box as recited in claim 1, further comprising an antenna coupled to the busing architecture, the processor-executable instructions including instructions that, when executed, cause the processor to receive technical instructions via the antenna.

4. The set-top box as recited in claim 1, wherein the technical protocol establishes a valid time source at the set-top box.

5. The set-top box as recited in claim 1, wherein the technical protocol establishes a valid entertainment guide at the set-top box.

6. The set-top box as recited in claim 1, wherein the technical protocol establishes digital channel tuning at the set-top box from the television input.

7. The set-top box as recited in claim 1, wherein the technical protocol establishes valid signal quality at the set-top box from the television input.

8. The set-top box as recited in claim 1, wherein the technical protocol establishes valid television control signals at the set-top box being sent via the television output.

9. The set-top box as recited in claim 1, wherein the technical protocol establishes valid network connectivity at the set-top box.

10. The set-top box as recited in claim 1, wherein the technical protocol establishes valid wireless connectivity at the set-top box.

11. The set-top box as recited in claim 1, wherein the technical protocol establishes a valid room identification at the set-top box.

12. The set-top box as recited in claim 1, wherein the machine-readable optical label further comprises a Quick Response (QR) code.

13. The set-top box as recited in claim 1, wherein the machine-readable optical label further comprises diagnostic information about the status of the technical protocol.

14. The set-top box as recited in claim 1, wherein the human-readable visual label further comprises visual indicators about the status of the technical protocol.

15. The set-top box as recited in claim 1, wherein the human-readable visual label and the machine-readable optical label further comprise an overlay signal superposed on the output signal.

16. The set-top box as recited in claim 1, wherein the human-readable visual label and the machine-readable optical label comprise an insert signal embedded into the output signal.

17. The set-top box as recited in claim 1, wherein the human-readable visual label and the machine-readable optical label comprise a screen signal defining the output signal.

18. A set-top box with technical configuration comprising:
a housing securing a television input, a television output, a processor, memory, storage, a first tuner, and a second tuner therein;
a busing architecture communicatively interconnecting the television input, the television output, the processor, the memory, the storage, the first tuner, and the second tuner therebetween;
an antenna coupled to the busing architecture;
the television input configured to receive a source signal from an external source;
the television output configured to forward an output signal to a television; and
the memory accessible to the processor, the memory including processor-executable instructions that, when executed, cause the processor to:
receive technical instructions via the antenna;
execute an technical protocol to make the set-top box and television ready for use, the technical protocol relates to a protocol selected from the group consisting of installation, maintenance, and repairs;
generate a human-readable visual label that contains information about the status of the technical protocol;
generate a machine-readable optical label that contains information about the status of the technical protocol, the machine-readable optical label being a Quick Response (QR) code;
forward, via the television output, the output signal including the human-readable visual label and the machine-readable optical label; and
dynamically update the human-readable visual label and the machine-readable optical label as the status of the technical protocol changes.

19. The set-top box as recited in claim 18, wherein the human-readable visual label and machine-readable optical label further comprise a signalization selected from the group consisting of an overlay signal superposed on the output signal, an insert signal embedded into the output signal, and a screen signal defining the output signal.

20. A set-top box with technical configuration comprising:
a housing securing a television input, a television output, a processor, memory, storage, a first tuner, and a second tuner therein;
a busing architecture communicatively interconnecting the television input, the television output, the processor, the memory, the storage, the first tuner, and the second tuner therebetween;
the television input configured to receive a source signal from an external source;
the television output configured to forward an output signal to a television; and
the memory accessible to the processor, the memory including processor-executable instructions that, when executed, cause the processor to:
execute a technical protocol to make the set-top box and television ready for use;
generate a human-readable visual label that contains information about the status of the technical protocol;
generate a machine-readable optical label that contains information about the status of the technical protocol;
forward, via the television output, the output signal including the human-readable visual label and the machine-readable optical label; and
dynamically update the human-readable visual label and the machine-readable optical label as the status of the technical protocol changes, wherein
the human-readable visual label and machine-readable optical label further comprise a signalization selected from the group consisting of an overlay signal superposed on the output signal, an insert signal embedded into the output signal, and a screen signal defining the output signal.

21. The set-top box as recited in claim 20, wherein the machine-readable optical label further comprises a Quick Response (QR) code.
